(19) United States
(12) Patent Application Publication
(10) Pub. No.: US 2026/0273576 A1
(43) Pub. Date: Sep. 17, 2026

(54) ULTRASONIC TRANSDUCER, A METHOD FOR TRANSMITTING OF AN ULTRASOUND WAVE, AND A METHOD FOR DETECTING OF AN ULTRASOUND WAVE

(71) Applicant: IMEC VZW, Leuven (BE)

(72) Inventors: Samer HOURI, Louvain-la-Neuve (BE); Rachid HAOUARI, Sint-Jan Molenbeek (BE)

(21) Appl. No.: 19/558,101

(22) Filed: Mar. 5, 2026

(30) Foreign Application Priority Data
Mar. 11, 2025 (EP) 25163066.1

(51) Int. Cl. B06B 1/02; B06B 1/06

(52) U.S. Cl. CPC B06B 1/0292; B06B 1/0644

(57) ABSTRACT

An ultrasonic transducer comprising: a substrate comprising a frontside configured to face an external medium for propagation of an ultrasound wave; and a membrane arranged to be suspended at a distance from a cavity surface of the substrate for defining a cavity between the membrane, the cavity surface, and at least one cavity wall, wherein the membrane is configured to transversally vibrate; wherein the ultrasonic transducer comprises a venting hole at the frontside and a venting channel configured to connect the cavity to the venting hole; wherein the transducer has an acoustic resonance frequency and the membrane has a membrane resonance frequency, and wherein the ultrasonic transducer is configured to provide transduction for the ultrasound wave having a frequency corresponding to the acoustic resonance frequency.

### CROSS-REFERENCE TO RELATED APPLICATION

The present application claims the benefit of and priority to EP patent application Ser. No. 25/163,066.1, filed Mar. 11, 2025, the entire contents of which is incorporated herein by reference.

### TECHNICAL FIELD

The present description relates to an ultrasonic transducer. The present description also relates to a method for transmitting of an ultrasound wave, and a method for detecting of an ultrasound wave.

### BACKGROUND

Micromachined ultrasonic transducers are small electronic components comprising a membrane configured for the transduction of an ultrasonic signal through transversal vibration of the membrane. Micromachined ultrasonic transducers are an interesting alternative to large-size ultrasonic transducers that are conventionally used for, e.g., ultrasonic imaging and non-destructive testing.

However, micromachined ultrasonic transducers operate on resonance, meaning that an operational frequency, i.e., a frequency being transmitted and/or received by the ultrasonic transducer, depends on a size of the membrane of the micromachined ultrasonic transducer. Consequently, lower operational frequencies require larger membranes. For manufacturing reasons, there are, however, practical constraints as to how large the size of the membrane can be. This constraint translates to a corresponding constraint with regard to a lowest frequency that the micromachined ultrasonic transducer can transduce. In practical applications, for the reason above, it is challenging to efficiently operate a micromachined ultrasonic transducer at frequencies lower than 0.5 MHz.

### SUMMARY

An objective of the present description is to enable efficient transduction of an ultrasonic signal at low frequencies. It is a particular objective to provide an ultrasonic transducer capable of efficiently operating at lower frequencies, where the ultrasonic transducer is suitable for being manufactured using micromachining.

These and other objectives are at least partly met by the invention as defined in the independent claims. Preferred embodiments are set out in the dependent claims.

According to a first aspect, there is provided an ultrasonic transducer comprising:
a substrate comprising a frontside configured to face an external medium for propagation of an ultrasound wave; and
a membrane arranged to be suspended at a distance from a cavity surface of the substrate for defining a cavity between the membrane, the cavity surface, and at least one cavity wall, wherein the membrane is configured to transversally vibrate;
wherein the ultrasonic transducer comprises at least one venting hole wall at the frontside for defining a venting hole at the frontside;
wherein the ultrasonic transducer further comprises at least one venting channel wall defining a venting channel configured to connect the cavity to the venting hole;
wherein the transducer has an acoustic resonance frequency and the membrane has a membrane resonance frequency, wherein the acoustic resonance frequency is different from the membrane resonance frequency, and wherein the ultrasonic transducer is configured to provide transduction for the ultrasound wave propagating in the external medium, wherein the ultrasound wave has a frequency corresponding to the acoustic resonance frequency.

An advantage of the ultrasonic transducer of the first aspect is that the ultrasonic transducer can efficiently transduce a frequency different than the membrane resonance frequency. Thanks to the ultrasonic transducer comprising venting hole(s), venting channel(s) and a cavity, an acoustic resonance frequency is provided. The ultrasonic transducer is therefore not limited to efficiently operate at a resonance frequency defined by a size of the membrane.

This implies that the ultrasonic transducer may comprise a membrane of a relatively small size associated with a membrane resonance frequency that is higher than the acoustic resonance frequency. Still, the ultrasonic transducer may be configured to operate at the acoustic resonance frequency. Hence, the ultrasonic transducer may have a small membrane while being able to operate at low frequencies.

This is especially useful when the membrane is subjected to constraints affecting the size of the membrane and hence the membrane resonance frequency. In particular, micromachined ultrasonic transducers may have a constraint in the size of the membrane. However, thanks to the ultrasonic transducer being able to operate at the acoustic resonance frequency, the ultrasonic transducer may be manufactured using micromachining technology and be able to operate at low frequencies. Further, the frequency of the transduced ultrasonic wave can be customized when designing the transducer by adapting the geometry and/or volume of the cavity and/or venting channel and/or venting hole.

The ultrasonic transducer may further have a relatively small size while being able to operate at low frequencies. This may be advantageous for providing the ultrasonic transducer in an array of ultrasonic transducers.

The ultrasonic transducer comprises a substrate. The substrate may be a solid medium which allows processing to form a desired geometry on or in the substrate. For instance, the substrate may be processed to form cavities, channels, holes, etc., in the substrate. Alternatively or additionally, material may be deposited on the substrate for forming the desired geometry. The substrate may be shaped through, e.g., deposition, removal, and/or patterning steps.

The substrate may be formed by a material suitable for processing for forming miniature structures, such as in micrometer or millimeter scale. The substrate may thus be formed by a semiconductor material, which may facilitate use of semiconductor processing technology for forming structures on or in the substrate. The substrate may for instance be formed by silicon.

The substrate comprises a frontside configured to face an external medium for propagation of an ultrasound wave. The frontside may thus be a surface of the substrate.

The external medium may be any suitable medium in relation to which the ultrasonic transducer is to be used. The external medium may for instance be a fluid, e.g., a liquid or a gas, such as air. However, it should be noted that the ultrasound wave can also be propagated in an external solid medium, by the frontside of the substrate being placed in close proximity or contact with the external solid medium.

It should be realized that the cavity, the venting hole, and the venting channel may be filled by a fluid, e.g., a liquid or a gas. Typically, the cavity, the venting hole, and the venting channel may be filled by air.

The ultrasonic transducer comprises a membrane arranged to be suspended at a distance from a cavity surface of the substrate for defining a cavity between the membrane, the cavity surface, and at least one cavity wall. The membrane being suspended implies that the membrane is supported in one or more locations and extends from the one or more locations to be movable in relation to the cavity surface of the substrate in portions of the membrane. The membrane may for instance be supported at one or more edges and may extend between locations being supported. Thus, the membrane may be supported by a cavity wall along a perimeter of the membrane. The cavity wall may form part of the substrate and/or may be formed on the substrate such that the cavity wall is physically connected to the substrate.

The cavity wall may extend between a surface of the substrate and the membrane, such as between a surface of the frontside of the substrate and the membrane or between a surface of a backside of the substrate and the membrane. Thus, the cavity wall(s) may define the distance between the membrane and the cavity surface of the substrate and may surround the cavity between the membrane and the cavity surface of the substrate.

The cavity surface of the substrate is a surface of the substrate that faces the membrane. It should be realized that the cavity may be formed extending into the substrate. The cavity may be defined by selectively etching into the substrate, or otherwise removing material of the substrate. Thus, the cavity surface may be defined as a bottom surface formed by selective etching into the substrate. Hence, the membrane may be suspended above this bottom surface formed in an indentation extending into the substrate.

According to an alternative, the cavity may be formed on the substrate. The cavity may thus be defined by at least one cavity wall being formed on the surface of the frontside of the substrate, such that the membrane may be supported above the structure formed by the frontside of the substrate. In such case, the cavity surface may be defined by the frontside of the substrate on which the cavity walls are formed.

It should be further realized that the cavity may alternatively be formed at a backside opposite to the frontside of the substrate. Thus, the cavity may instead be formed extending into the substrate at the backside of the substrate or may be formed on the backside of the substrate.

It should be realized that at least one cavity wall may define the cavity. For instance, a single cavity wall may define the cavity having a circular cross-section, wherein the cross section may be in a plane parallel to the frontside and/or the cavity surface of the substrate. However, cavities in other shapes may be defined by a plurality of cavity walls, such as four cavity walls defining a square-shaped cavity.

The membrane may be configured to face the substrate with the cavity being arranged between the membrane and the substrate. For instance, the membrane may, when unaffected by any force causing vibrations of the membrane, be parallel with the cavity surface of the cavity formed in or on the substrate.

The membrane may be thin in a direction along a normal to the cavity surface of the substrate. The membrane may have a larger extension along a direction parallel to the cavity surface of the substate than in the orthogonal direction along the normal to the cavity surface.

The membrane may be pliable and/or flexible and configured to move during transduction of the ultrasound wave by the ultrasonic transducer. It should be realized that part of the membrane may be moved such that the membrane may be deformed during transduction of the ultrasound wave.

The membrane is configured to transversally vibrate. By the term “transversally vibrate” it is here meant that the membrane can move back and forth in an oscillating manner along a direction toward the cavity surface of the substrate. Thus, the membrane is configured to move in a direction transverse to a direction of extension of the membrane. It should be noted that the membrane moving back and forth may imply that a perimeter of the membrane is fixedly suspended along a perimeter and the suspended membrane is elastically deformed back and forth along a direction toward the cavity surface in an oscillating manner.

The ultrasonic transducer comprises at least one venting hole wall at the frontside for defining a venting hole at the frontside. The at least one venting hole wall may be configured to surround the venting hole at cross-sections of the venting hole. It should be realized that the venting hole may be formed extending into the substrate. The venting hole may be defined by selectively etching into the substrate, or otherwise removing material of the substrate. Thus, a surface may be defined at a bottom of a structure formed by the selective etching. The venting hole wall(s) may extend from the bottom of the structure to an upper surface of the substrate.

According to an alternative, the venting hole may be formed in a structure on the substrate. The venting hole may thus be defined by at least one venting hole wall being formed on the surface of the frontside of the substrate.

It should be realized that at least venting hole wall may define the venting hole. For instance, a single venting hole wall may define the venting hole having a circular cross-section, wherein the cross section may be in a plane parallel to the frontside of the substrate and/or the surface at the bottom of the structure. However, venting holes in other shapes may be defined by a plurality of venting hole walls, such as four venting hole walls defining a square-shaped venting hole.

The venting hole may comprise an opening at end(s) of the venting hole wall(s) facing the external medium. The end(s) of the venting hole wall(s) facing the external medium may define a shape of this opening. The venting hole may thus be defined by the shape of the opening at the end(s) of the venting hole wall(s), by the venting hole wall(s) and by a bottom surface defined in or on the substrate facing the opening. The venting hole is in fluid connection with an exterior of the ultrasonic transducer. When the external medium is a fluid or gas, the venting hole is in fluid connection with the external medium.

According to an embodiment, the venting hole is laterally displaced from the membrane. This implies that the venting hole associated with the at least one venting hole wall and the cavity associated with the at least one cavity wall are positioned at different locations with respect to a plane associated with a frontside of the substrate. It should be realized that the venting hole and the cavity are not necessarily arranged in the same plane. However, an orthogonal projection of the opening of the venting hole onto a plane in which the membrane is arranged does not overlap with the membrane, and is hence, laterally displaced from the membrane. In particular, the venting hole may be laterally displaced from the membrane with the membrane being arranged at the frontside of the substrate.

The ultrasonic transducer comprises at least one venting channel wall defining a venting channel configured to connect the cavity to the venting hole. The at least one venting channel wall is configured to define a space that extends between the cavity and the venting hole. The at least one venting channel wall may be configured to surround the venting channel at cross-sections of the venting channel between the venting hole and the cavity. The cross section may be in a plane orthogonal to the frontside of the substrate. The venting channel is configured to allow a volume associated with the cavity to be in fluid connection with the exterior of the ultrasonic transducer via the venting hole and the venting channel.

The venting channel may be arranged within the substrate. However, the venting channel may alternatively be arranged in a structure on the substrate.

The venting channel may be connected to the cavity through an opening in the at least one cavity wall or through an opening in the cavity surface.

The transducer has an acoustic resonance frequency and the membrane has a membrane resonance frequency. The acoustic resonance frequency is a frequency associated with the geometry and/or volume of the cavity and/or venting channel and/or the venting hole. The acoustic frequency is associated with a geometry that is in fluid connection within the transducer and which is further in fluid connection with the exterior of ultrasonic transducer. A size and shape of the volume being in fluid connection within the transducer defines the acoustic resonance frequency. The acoustic resonance frequency may correspond to a natural frequency of a Helmholtz resonator defined by the geometry and volume being in fluid connection in relation to an undeformed membrane, i.e., when the membrane is not affected by a force causing vibrations of the membrane.

The membrane resonance frequency is a frequency associated with the geometry of the membrane. The membrane resonance frequency may be associated with a size, shape and material of the membrane. The membrane resonance frequency may for instance be a natural frequency of the membrane. The membrane resonance frequency may be defined by a size of the membrane. The membrane resonance frequency may correspond to a frequency at which a wavelength of the ultrasound wave corresponds to a distance between opposite fixed positions of the membrane, e.g., a distance corresponding to a diameter of the membrane. This may also be referred to as fundamental membrane resonance frequency.

The membrane resonance frequency may depend on the geometry of the membrane and material properties of the membrane. A membrane of a given size and shape which is constructed of a material with a relatively high stiffness may have a higher resonance frequency compared to a membrane of the same size and shape constructed of a material with a lower stiffness, and vice versa. A large membrane of a given shape and material may have a lower resonance frequency than a smaller membrane of the same shape and material, and vice versa. It should be noted that the manner in which the membrane is suspended may also affect the membrane resonance frequency. If the membrane is suspended in a way that subjects the membrane to tension, this may result in a higher resonance frequency than if the same membrane is suspended in a way that subjects it to less tension. The membrane resonance frequency may correspond to a mechanical bending wave of the membrane having fixed nodes, e.g., at edges of the membrane.

The membrane may have a fundamental resonance frequency corresponding to a lowest resonance frequency of the membrane. It should be realized that the membrane may have a plurality of harmonic membrane resonance frequencies. The harmonic membrane resonance frequencies may be integer multiples of the fundamental resonance frequency. The harmonic membrane resonance frequencies are larger than the fundamental membrane resonance frequency.

The fundamental membrane resonance frequency is dependent on the size of the membrane. An ultrasonic transducer operating at the fundamental membrane resonance frequency given by the size of the membrane may provide efficient transduction of the ultrasound wave. However, this implies that an ultrasound frequency at which transduction is desired defines the size of the membrane.

According to the ultrasonic transducer of the first aspect, the ultrasonic transducer is configured to provide transduction for the ultrasound wave propagating in the external medium, wherein the ultrasound wave has a frequency corresponding to the acoustic resonance frequency. Further, the acoustic resonance frequency is different from the membrane resonance frequency.

Thus, the ultrasonic transducer may be used to provide transduction for ultrasound waves at the acoustic resonance frequency and an operational frequency of the ultrasonic transducer is thus not limited by the size of the membrane. Hence, the ultrasonic transducer may be configured to provide transduction for the ultrasound wave having a frequency corresponding to the acoustic resonance frequency by the membrane vibrating at the acoustic resonance frequency.

According to an embodiment, the acoustic resonance frequency may be lower than the membrane resonance frequency.

This may be beneficial when the membrane is subjected to constraints limiting the lowest possible membrane resonance frequency. In particular, a maximum size of the membrane in manufacturing of the ultrasonic transducer may provide a limit to a lowest possible membrane resonance frequency.

Thanks to the ultrasonic transducer being configured with the acoustic resonance frequency being lower than the membrane resonance frequency, the ultrasonic transducer may efficiently transduce an ultrasonic wave of a frequency lower than that of the minimum membrane resonance frequency associated with a maximum size of the membrane.

It should be further realized that the ultrasonic transducer being configured to provide transduction of an ultrasound wave at the acoustic resonance frequency of the ultrasonic transducer also implies that a design of the size and shape of the membrane of the ultrasonic transducer is not critical to a function of the ultrasonic transducer. Hence, the ultrasonic transducer may be provided with a size and shape of the membrane which is designed without taking into account a desired operational frequency of the ultrasonic transducer.

It should be noted that in the ultrasonic transducer according to the first aspect, the membrane may vibrate below the lowest membrane resonance frequency. However, in case the ultrasonic transducer would not be designed with an acoustic resonance frequency, vibration of the membrane at a frequency lower than the lowest membrane resonance frequency would lead to an inefficiently transduced signal. In such case, due to losses, the power of the transduced signal may be significantly lower compared to a similar signal transduced at the membrane resonance frequency. In contrast, thanks to the ultrasonic transducer of the present description being configured to provide transduction of the ultrasound wave at the acoustic resonance frequency lower than the membrane resonance frequency, the ultrasonic transducer provides efficient transduction of the ultrasound wave.

According to an embodiment, the transducer may further comprise a control unit configured to control the membrane to vibrate at the acoustic resonance frequency.

The control unit may be any electronic circuitry or device configured to influence at least one of the amplitude of the vibration of the membrane and the frequency of the vibration of the membrane. The control unit may be configured to send a control signal to an actuator which may in turn cause the vibration of the membrane.

The control unit may be advantageously used in an ultrasonic transducer configured to transmit ultrasound waves into the external medium. Thus, the control unit may be used for controlling vibrations of the membrane for causing the ultrasonic transducer to transmit ultrasound waves.

An advantage of having a control unit configured to control the membrane to vibrate at the acoustic resonance frequency is at least that the vibrations of the membrane may give rise to fluid being forced in and out of the volume being in fluid connection within the transducer at the acoustic resonance frequency, e.g., the volume spanned by the cavity, the venting channel and the venting hole. The vibrations of the membrane being provided at the acoustic resonance frequency causes resonance in the volume. This resonance at the acoustic resonance frequency may correspond to a transmitted signal from the opening of the venting hole and a power of the transmitted signal may be amplified compared to a signal originating from the same membrane vibration without the acoustic resonance. In turn, this may enable an ultrasonic transducer having a membrane with constraints regarding the lowest membrane resonance frequency to efficiently transmit a signal below the lowest membrane resonance frequency.

According to an embodiment, the acoustic resonance frequency may be in a range of 20 kHz-1 MHz, such as in a range of 40-300 kHz, such as in a range of 60-200 kHz.

These frequencies lie in a range where micromachined ultrasonic transducers encounter problems regarding the efficient transduction of a signal due to size constraint of the membrane in manufacturing of the ultrasonic transducers. Embodiments of the ultrasonic transducer of the first aspect may improve the transduction of a signal with a frequency falling in the above ranges without needing to use a size of the membrane beyond size constraints of manufacturing of micromachined ultrasonic transducers.

According to an embodiment, a size of the membrane may be smaller than 400 μm, such as smaller than 250 μm.

The advantage may be that ultrasound transduction for ultrasound waves at low ultrasound frequencies may be achieved without necessarily using a correspondingly large size of the membrane, since the membrane resonance frequency need not match the low ultrasound frequency for which ultrasound transduction is provided. This implies that the ultrasonic transducer enables small, space efficient micromachined ultrasonic transducers.

Using a size of the membrane smaller than 400 μm, such as smaller than 250 μm, may imply that the ultrasonic transducer is suitable for being manufactured using micromachining. Membranes smaller than 500 μm may lead to easier and cheaper manufacturing. Smaller membranes may also save space in applications where space is a constraint.

The size of the membrane corresponds to a diameter of the membrane for a membrane having a circular perimeter. However, it should be realized that the size of the membrane may instead correspond to a size of a side of the membrane in e.g., a rectangular shape of the membrane.

According to an embodiment, the ultrasonic transducer may comprise a plurality of membranes, each arranged to be suspended at a distance from a respective cavity surface of the substrate, wherein the plurality of membranes define a plurality of cavities, wherein each cavity is defined between a respective membrane, a respective cavity surface, and at least one respective cavity wall, wherein each membrane is configured to transversally vibrate, wherein the ultrasonic transducer comprises at least one connecting channel wall defining at least one connecting channel between different cavities of the plurality of cavities.

The ultrasonic transducer may comprise a plurality of membranes. Each membrane may be arranged to be suspended at a distance from the respective cavity surface of the substrate as described in detail above. Thus, properties of the membrane described above may apply to each of the membranes.

The plurality of membranes may define a plurality of cavities. Each cavity of the plurality of cavities may be defined between a respective membrane, a respective cavity surface, and at least one respective cavity wall, as described above. Thus, properties of the cavity described above may apply to each of the cavities.

The ultrasonic transducer may comprise connecting channel walls. The connecting channel walls may define a plurality of connecting channels. A connecting channel may be defined by at least one connecting channel wall. For instance, a single connecting channel wall may define the connecting channel having a circular cross-section. The cross section may be in a plane orthogonal to the frontside of the substrate. However, connecting channels in other shapes may be defined by a plurality of connecting channel walls, such as four connecting channel walls defining a square-shaped connecting channel.

The at least one connecting channel wall is configured to define a space that extends between two cavities of the plurality of cavities. The at least one connecting channel wall may be configured to surround the connecting channel at cross-sections of the connecting channel between the cavities. The connecting channel is configured to allow volumes associated with the cavities to be in fluid connection with each other and further to be in fluid connection with the exterior of the ultrasonic transducer via at least one venting channel and at least one venting hole.

The connecting channel may be arranged within the substrate. However, the connecting channel may alternatively be arranged in a structure on the substrate.

Each membrane may be configured to transversally vibrate. Thus, the vibration of each of the membranes may be provided in a manner as described in detail for the membrane above.

The ultrasonic transducer comprising a plurality of membranes and a plurality of cavities connected by connecting channels may enable a strong transduction of an ultrasound wave. The plurality of membranes in combination with the plurality of cavities may be used in combination for providing a large signal strength of a transduced ultrasound signal.

The ultrasonic transducer may allow low frequencies to be transduced by combining vibrating membranes instead of increasing the size of an individual membrane. By connecting different cavities with connecting channels, a space in which acoustic resonance may take place may be increased. The volume of this space may be customized during manufacturing by connecting a desired amount of cavities forming a corresponding fluidly connected space. Thus, the acoustic resonance frequency may be designed based on the design of the fluidly connected space within the ultrasonic transducer.

The plurality of membranes may be configured to vibrate at a common frequency being the acoustic resonance frequency of the ultrasonic transducer. Where the ultrasonic transducer is used for transmitting an ultrasound wave, the plurality of membranes may thus be used in combination for ensuring that a strong signal of the transmitted ultrasound wave is provided.

The plurality of membranes and the plurality of cavities may have identical size and shapes. This may facilitate manufacturing efficiency as a plurality of identical structures may be manufactured side-by-side in the ultrasonic transducer.

Manufacturing could start from a partly finished substrate template comprising a plurality of partly finished cavities. A desired configuration of venting holes, venting hole channels and connecting channels may be formed at a later manufacturing stage. This allows for the manufacturing of ultrasonic transducers having different acoustic properties starting from the same template. The formation of connecting channels, venting holes and venting channels can be achieved by adding or removing material to the template or a combination thereof.

In such embodiments, each of the plurality of cavities may be connected to at least one other cavity in the plurality of cavities by a connecting channel of the at least one connecting channel, wherein all cavities of the plurality of cavities may be connected.

Connecting channels form part of a volume that may resonate at an acoustic resonance frequency. A set number of cavities may be interconnected in different ways with different amount of connecting channels. Changing the number of connecting channels connecting a set number of cavities may provide additional adjustment to the desired space in which acoustic resonance may take place, thus adjusting the acoustic resonance frequency. In addition, the way in which a set of cavities are interconnected by connecting channels may influence the acoustic resonance frequency.

Further, a configuration in which all cavities are interconnected may result in a strong transduction of the ultrasound wave at a low acoustic resonance frequency compared to having a single membrane and cavity or having disconnected cavities. Further, using all membranes and cavities in transduction of the ultrasound wave may contribute to efficient use of space.

In such embodiments, the ultrasonic transducer may comprise a plurality of venting hole walls, at the frontside for defining respective venting holes at the frontside, wherein the ultrasonic transducer further comprises venting channel walls defining a plurality of venting channels configured to connect a respective venting hole of the plurality of venting holes to a respective cavity of the plurality of cavities.

The ultrasonic transducer may comprise a plurality of venting hole walls defining a plurality of venting holes. Each venting hole may be defined by at least one venting hole wall, as described above. Thus, properties of the venting hole walls and venting holes described above may apply to each of the venting hole walls and venting holes.

The ultrasonic transducer may further comprise venting channel walls defining a plurality of venting channels. Each venting channel may be defined by at least one venting channel wall, as described above. Thus, properties of the venting channel walls and venting channels described above may apply to each of the venting channel walls and venting channels.

The venting channels may be configured to connect a respective venting hole of the plurality of venting holes to a respective cavity of the plurality of cavities. This implies that each cavity may be associated with a respective venting channel and a respective venting hole. The cavity together with the respective venting channel and respective venting hole may be associated with an acoustic resonance frequency. Thus, each combination of a cavity, venting channel and venting hole may define an acoustic resonance frequency corresponding to forcing a fluid in and out of the volume formed by the cavity, the venting channel and the venting hole. The plurality of cavities may thus each be associated with the same acoustic resonance frequency based on identical geometry of the cavity, venting channel and venting hole. By the cavities being in fluid connection with each other through the connecting channels, strong transduction by the ultrasonic transducer of the acoustic wave at the acoustic resonance frequency may be provided.

It should be realized that the connecting channels may further affect the acoustic resonance frequency of the ultrasonic transducer. Thus, the acoustic resonance frequency of the combined fluidly connected space need not correspond exactly to the resonance frequency that would be defined by a single combination of cavity, venting channel and venting hole.

A configuration like the one above, comprising a plurality of venting holes and venting channels may allow further customization of an interconnected volume of the fluidly connected space of the ultrasonic transducer. Customizing the configuration of cavities connected to a venting hole may allow distributing a pressure wave created by an oscillating medium. This may affect the acoustic resonance frequency.

It should further be realized that a cavity may be associated with more than one venting hole. Thus, a cavity may for instance be associated with two venting holes, each connected to the cavity through a respective venting channel.

The ultrasonic transducer may be provided with more than one venting hole in an embodiment comprising a single cavity. The more than one venting channel and more than one venting hole may be used for defining a desired acoustic resonance frequency. Thus, a number of venting channels and venting holes may be a design parameter in design of the ultrasonic transducer.

Also, in an embodiment comprising the plurality of cavities, cavities may be associated with more than one venting hole. This may be used for defining the acoustic resonance frequency of the fluidly connected space.

It should also be realized that each cavity need not necessarily be associated with an identical number of venting holes. Rather, different cavities may be associated with different numbers of venting holes. In particular, the ultrasonic transducer may comprise a smaller number of venting holes than cavities. Thus, there may be one venting hole per two cavities or one venting hole per four cavities. The number of cavities per venting hole may also be a design parameter in design of the ultrasonic transducer.

According to an embodiment, a square root of a ratio defined by a sum of cross-sectional areas of each venting hole divided by a product of a volume of each cavity multiplied by the length of the venting channel is within a range of 400-20000, such as in a range of 400-10000 or in a range of 1000-2000.

A relation defined by the square root of the ratio provides a suitable design parameter of the ultrasonic transducer. Thus, the relation may be used for ensuring a proper design of properties of the ultrasonic transducer.

The relation being within a range of 400-20000, such as in a range of 400-1000 or in a range of 1000-2000 may ensure that the ultrasonic transducer may be set to provide transduction of an ultrasound wave at an acoustic resonance frequency at low frequencies.

According to an embodiment, the ultrasonic transducer may be a capacitive micromachined ultrasonic transducer, CMUT.

According to an embodiment, the ultrasonic transducer may be a piezoelectric micromachined ultrasonic transducer, PMUT.

While the configurations of ultrasonic transducers described above may provide benefits for ultrasonic transducers of a wide range of sizes, the configurations are particularly beneficial for micromachined ultrasonic transducers. The ultrasonic transducer may thus be a CMUT or a PMUT. These are suitable alternatives for providing a miniature ultrasonic transducer.

The CMUT may comprise the membrane suspended in relation to the cavity surface, wherein a top electrode is provided on the membrane and a bottom electrode is provided at the cavity surface, such that a varying capacitance is provided based on vibrations of the membrane.

The PMUT may comprise the membrane suspended in relation to the cavity surface, wherein the membrane comprises a thin piezoelectric film providing an electrical signal based on vibrations of the membrane.

The CMUT or the PMUT may be manufactured using micromachining. This implies that the ultrasonic transducer may be manufactured using technology allowing manufacturing of structures on micrometer scale. The micromachining may involve deposition, removal, and/or patterning steps. The micromachining may be performed using surface micromachining and/or bulk micromachining. The manufacturing of the CMUT or the PMUT may also involve bonding of one or more structures that are separately formed to each other.

According to a second aspect of the invention, there is provided a method for transmitting of an ultrasound wave, said method comprising:
driving a vibration of a membrane of an ultrasonic transducer, wherein the membrane is arranged to be suspended at a distance from a cavity surface of a substrate of the ultrasonic transducer for defining a cavity between the membrane, the cavity surface, and at least one cavity wall of the ultrasonic transducer, wherein the membrane is configured to transversally vibrate, wherein the ultrasonic transducer comprises at least one venting hole wall at the frontside for defining a venting hole at the frontside, wherein the ultrasonic transducer further comprises at least one venting channel wall defining a venting channel configured to connect the cavity to the venting hole, wherein the transducer has an acoustic resonance frequency and the membrane has a membrane resonance frequency, wherein the acoustic resonance frequency is different from the membrane resonance frequency, wherein the membrane is driven at the acoustic resonance frequency; and
transmitting the ultrasound wave into an external medium at the acoustic resonance frequency.

A transmitting method as described above may have a wide range of practical applications where an ultrasonic wave needs to be transmitted by a small device. In particular, the method above may efficiently transmit ultrasonic waves at low frequencies without the need of a large size of the membrane.

According to a third aspect of the invention, there is provided a method for detecting of an ultrasound wave, said method comprising:
receiving the ultrasound wave at an ultrasonic transducer comprising: a substrate comprising a frontside configured to face an external medium for propagation of the ultrasound wave; a membrane arranged to be suspended at a distance from a cavity surface of the substrate for defining a cavity between the membrane, the cavity surface, and at least one cavity wall, wherein the membrane is configured to transversally vibrate; wherein the ultrasonic transducer comprises at least one venting hole wall at the frontside for defining a venting hole at the frontside, wherein the ultrasonic transducer further comprises at least one venting channel wall defining a venting channel configured to connect the cavity to the venting hole, wherein the transducer has an acoustic resonance frequency and the membrane has a membrane resonance frequency, wherein the acoustic resonance frequency is different from the membrane resonance frequency, wherein the received ultrasound wave has a frequency corresponding to the acoustic resonance frequency; and
detecting a vibration of the membrane at the frequency of the ultrasound wave, wherein the vibration is caused by the received ultrasound wave.

A method for detecting an ultrasonic wave as described above may have a wide range of practical applications where an ultrasonic signal needs to be detected by a small device. In particular, the method above may efficiently detect ultrasonic waves at low frequencies without the need of a large size of the membrane.

### BRIEF DESCRIPTION OF THE DRAWINGS

The above, as well as additional objects, features, and advantages of the present description, will be better understood through the following illustrative and non-limiting detailed description, with reference to the appended drawings. In the drawings like reference numerals will be used for like elements unless stated otherwise.

FIG. 1a is a schematic view of a cross section of an ultrasonic transducer according to an embodiment.

FIG. 1b is a schematic view of a cross section of an ultrasonic transducer illustrating the vibration of the membrane.

FIG. 1c is a schematic view of a cross section of an ultrasonic transducer according to another embodiment.

FIG. 2a is a schematic view of a cross section of an ultrasonic transducer according to an embodiment comprising two membranes.

FIG. 2b is a schematic view of a cross section of an ultrasonic transducer according to an embodiment comprising two membranes.

FIG. 3 is a schematic view of an ultrasonic transducer comprising a plurality of interconnected membranes according to an embodiment.

FIG. 4 is a schematic view of a variation of the ultrasonic transducer of FIG. 3 according to an embodiment.

FIG. 5 is a flowchart of a method for transmitting an ultrasound wave according to an embodiment.

FIG. 6 is a flowchart of a method for receiving an ultrasound wave according to an embodiment.

### DETAILED DESCRIPTION

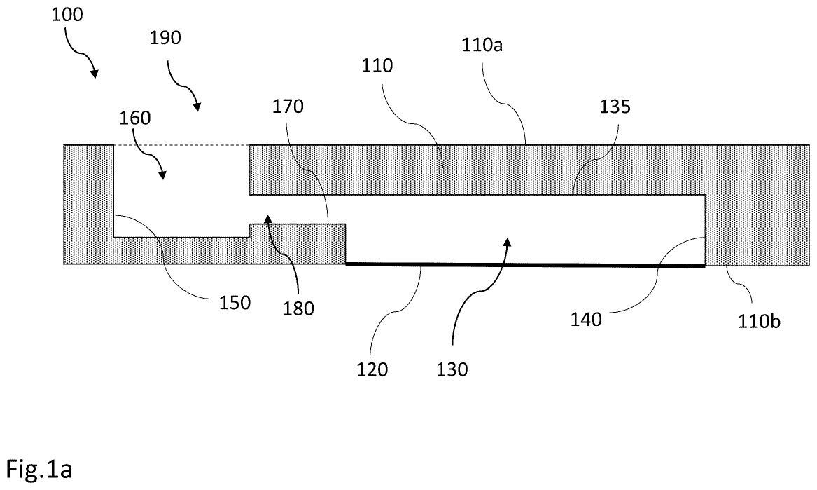

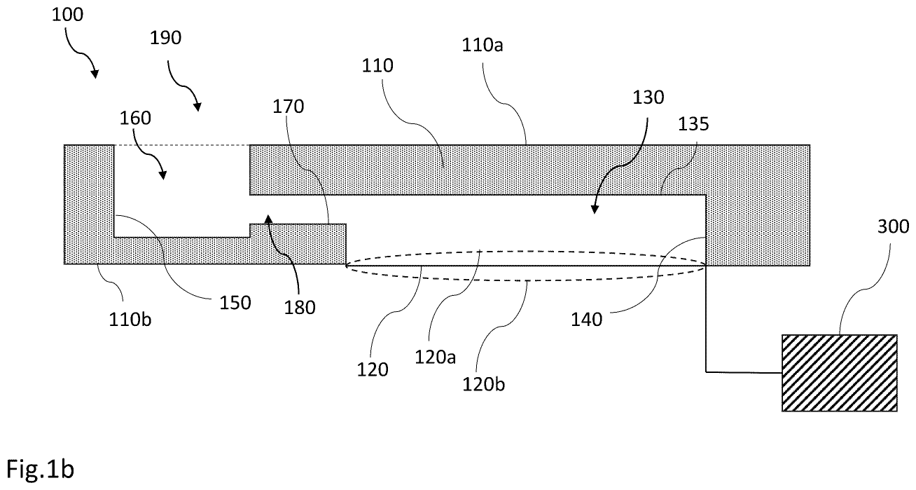

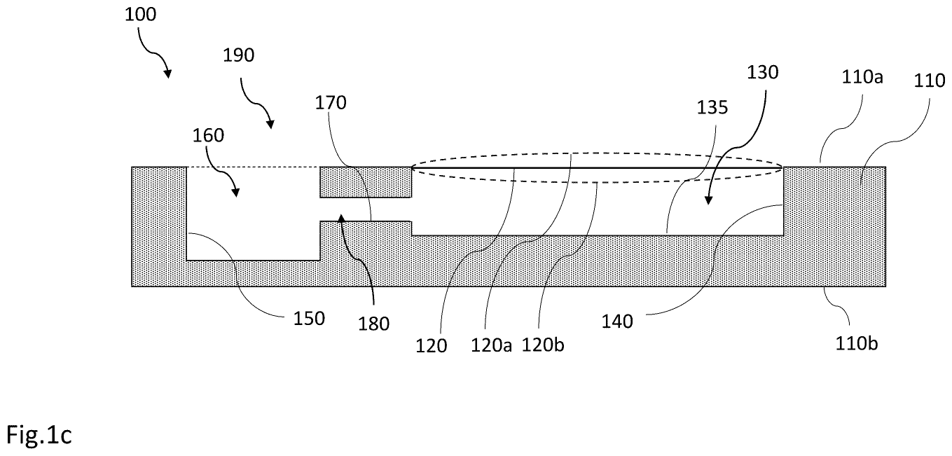

Referring now to FIG. 1a, an ultrasonic transducer 100 according to an embodiment is described.

The ultrasonic transducer 100 comprises a substrate 110. The substrate comprises a frontside 110a. The ultrasonic transducer 100 may be used with the frontside 110a of the substrate 110 facing an external medium 190 in which the ultrasound wave is to be propagated.

The ultrasonic transducer comprises a membrane 120. While not shown by the cross-sectional view of FIG. 1, the membrane 120 of the present embodiment may have a circular shape. The membrane 120 is suspended at a distance from cavity surface 135 of the substrate 100.

A cavity 130 is defined between the cavity surface 135, the membrane 120, and a cavity wall 140. The cavity wall 140 may have a circular shape matching the circular shape of the membrane 120. In this embodiment, the membrane 120 is attached to the cavity wall 140 along its perimeter. It should be noted that the membrane 120 may be suspended in alternative ways, for example, in alternative embodiments (not shown) where a plurality of cavity walls define a polygon, the membrane may be attached to the cavity wall at the vertices of the polygon.

In FIG. 1a, the cavity 130 is defined extending into the substrate 100 at a backside 110b of the substrate 100 opposite to the frontside 110a. However, it should be realized that the cavity 130 may alternatively be defined by the cavity wall 140 extending away from the backside 110b of the substrate 100 along a direction parallel to a normal to the backside 110b of the substrate 100. Further, the cavity 130 may alternatively be defined at the frontside 110a of the substrate 100.

The membrane 120 is configured to transversally vibrate. Thus, the membrane 120 may move back and forth towards the cavity surface 135. The membrane 120 and/or the cavity surface 135 may be provided with transducer components for converting an electrical signal to a movement of the membrane and/or for converting movement of the membrane to an electrical signal. For instance, the ultrasonic transducer 100 may form a capacitive micromachined ultrasonic transducer (CMUT) or a piezoelectric micromachined ultrasonic transducer (PMUT).

The substrate 110 comprises at least one venting hole wall 150. The venting hole wall 150 is located at the frontside 110a of the substrate 110. The venting hole wall 150 defines a venting hole 160. The venting hole 160 is located at the front side 110a and extends into the substrate 110. The venting hole 160 is laterally displaced from the membrane 120.

The substrate 110 comprises venting channel walls 170. The venting channel wall 170 defines a venting channel 180. The venting channel 180 extends within the substrate 110. The venting channel 180 in the present embodiment has a rectangular cross section along a direction of elongation of the venting channel 180, correspondingly, there are four venting channel walls 170 in the present embodiment (not visible in the present cross-sectional view). It should be noted that alternative embodiments (not shown) may have circular-cylindrical venting hole channels defined by a single venting channel wall. The venting hole channel 180 connects the cavity 130 to the venting hole 160. The cavity 130 and the venting hole 160 are fluidly connected through the venting channel 180. The cavity 130 is fluidly connected to an external medium 190 through the venting channel 180 and the venting hole 160.

The cavity, the venting hole, and the venting channel may be filled by a fluid medium, e.g., a liquid or a gas. Typically, the cavity, the venting hole, and the venting channel may be filled by air.

FIG. 1b shows the same cross-sectional view of a similar ultrasonic transducer 100 as in FIG. 1a, and further illustrates the transversal vibration of the membrane 120. The membrane 120 oscillates back and forth along a direction towards the cavity surface 135 of the substrate 110. This movement may be formed by elastic deformation. The perimeter of the membrane 120 remains fixed to the cavity wall 140. In a state illustrated by the dashed line 120a, the membrane is elastically warped toward the surface of the substrate 110a. As the membrane 120 elastically warps towards the surface of the substrate 110a, a volume of the cavity 130 is reduced and the fluid medium is pumped out of the cavity 130 via the venting channel 180 and via the venting hole 160. In a state illustrated by the dashed line 120b, the membrane is elastically warped away from the frontside of the substrate 110a. As the membrane 120 elastically warps away from the surface of the substrate 110a, the volume of the cavity 130 increases and the fluid medium is sucked into the cavity 130 via the venting hole 160 and the venting channel 180.

The fluid medium may be the same as the external medium 190 in case the external medium 190 is fluid. In the embodiments shown in FIGS. 1a and 1b, both the fluid medium and the external medium 190 are air. It should be noted that the fluid medium may be other gases, mixtures of gases, liquids or mixtures of liquids. It should also be noted that the fluid medium may affect resonance frequencies of the ultrasonic transducer 100.

According to an alternative embodiment (not shown), the membrane may be rigid and movably suspended at a cavity wall. In such an alternative embodiment, a movable or elastic connection (not shown) may be provided between the membrane and the cavity wall allowing the membrane to be moved in relation to the cavity surface. In such an alternative embodiment, the movable or elastic connection may influence a resonance frequency of the membrane.

In another alternative embodiment (not shown), the ultrasonic transducer may be intended to be placed against a solid external medium (not shown), such that the venting hole may be sealed by the solid external medium along the dashed line at an opening of the venting hole 160 at the frontside 110a. As a consequence, no fluid medium may enter or exit through the venting hole, whereby the movement of the membrane causes a change in pressure of the fluid medium. The change in pressure of the fluid medium may propagate through the solid external medium.

The transducer 100 has an acoustic resonance frequency. The acoustic resonance frequency of the transducer 100 in FIG. 1b is associated with a volume of the cavity 130, the venting channel, 180 and the venting hole 160, and the geometry of said volume. The volume of the venting hole 160 is spanned by the at least one venting hole wall and a plane associated with the frontside of the substrate 110a, schematically indicated by a dashed line in FIG. 1b.

The transducer 100 has a membrane resonance frequency defined by the shape, material and size of the membrane 120.

The acoustic resonance frequency is different from the membrane resonance frequency. The ultrasonic transducer 100 is configured to provide transduction for an ultrasound wave propagating in the external medium. The ultrasound wave has a frequency corresponding to the acoustic resonance frequency. It should be noted that the transduced ultrasound wave may vary/shift depending on the medium in which it propagates.

Thanks to the ultrasonic transducer 100 being configured to provide transduction of the ultrasound wave having a frequency corresponding to the acoustic resonance frequency, the size of the membrane 120 of the ultrasonic transducer 100 need not match the frequency of the ultrasound wave.

In particular, the ultrasonic transducer 100 may operate at a frequency different from a membrane resonance frequency. The ultrasonic transducer 100 may be designed to provide an acoustic resonance frequency that matches a desired operational frequency of the ultrasonic transducer 100.

The acoustic resonance frequency provided by the ultrasonic transducer 100 may be controlled by setting dimensions of the cavity 130, the venting channel 160 and the venting hole 180. The acoustic resonance frequency may further be controlled by controlling a number of venting holes associated with the cavity 130.

In the ultrasonic transducer 100 of FIG. 1b, the acoustic resonance frequency is lower than the membrane resonance frequency. It should be realized that the membrane resonance frequency may be inversely proportional to a size of the membrane. Thus, if a low membrane resonance frequency is desired, the size of the membrane needs to be large. However, thanks to the ultrasonic transducer 100 being configured to operate at the acoustic resonance frequency and not at the membrane resonance frequency, the membrane may have a small size such that the membrane resonance frequency may be higher than the frequency at which the ultrasonic transducer 100 operates.

As illustrated in FIG. 1b, the ultrasonic transducer 100 further comprises a control unit 300 for allowing the ultrasonic transducer 100 to be used for transmitting an ultrasonic wave into the external medium 190. The control unit 300 is configured to control the membrane 120 to vibrate at the acoustic resonance frequency.

The ultrasonic transducer 100 may be designed to provide the acoustic resonance frequency in the range of 20 kHz-1 MHz, such as in the range of 40-300 kHz, such as in the range of 60-200 KHz.

The membrane 120 of the ultrasonic transducer 100 may have a size smaller than 400 μm, such as smaller than 250 μm. The membrane 120 may for instance be circular with a diameter smaller than 400 μm, such as smaller than 250 μm. This may facilitate manufacturing of the ultrasonic transducer 100 since manufacturing of a micromachined ultrasonic transducer 100, such as a PMUT or CMUT, with a large membrane may not be readily available. For instance, the membrane resonance frequency of a circular membrane having a diameter of 250 μm is 1.2 MHz.

Referring now to FIG. 1c, an ultrasonic transducer 100 according to another embodiment is described.

The ultrasonic transducer 100 shown in FIG. 1c corresponds to the ultrasonic transducer shown in FIG. 1a. Features shared by the ultrasonic transducers in FIGS. 1a and 1c are not further discussed in detail here.

As shown in FIG. 1c, the ultrasonic transducer 100 comprises a membrane 120 arranged at the frontside 110a of the substrate 110. The membrane 120 is suspended at a distance from a cavity surface 135 of the substrate 110.

The membrane 120 is configured to transversally vibrate. The membrane 102 may for instance vibrate between the states indicated by dashed lines 120a and 120b.

The cavity 130 is defined between the cavity surface 135, the membrane 120, and the cavity wall 140. The cavity 130 extends into the substrate 110 at the frontside 110a of the substrate 110.

Similar to the embodiment in FIG. 1a, the substrate 110 comprises a venting hole wall 150 defining a venting hole 160 and venting channel walls 170 defining a venting channel 180, connecting the cavity 130 to the venting hole 160.

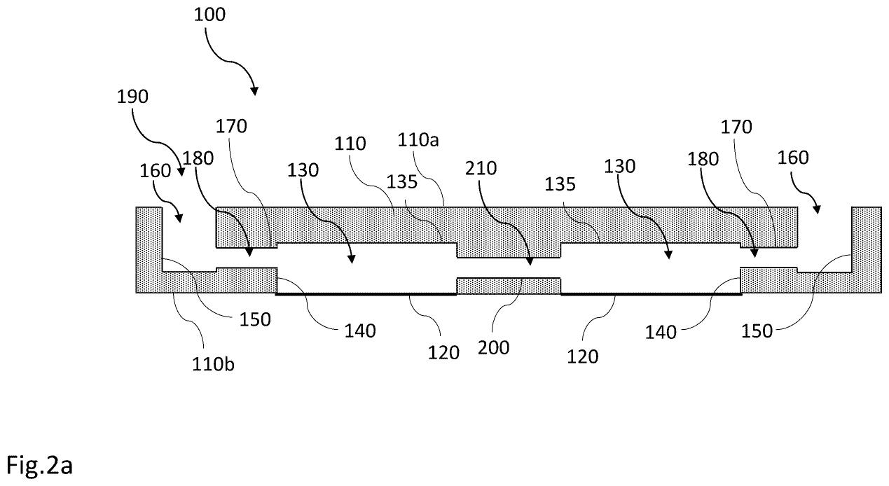

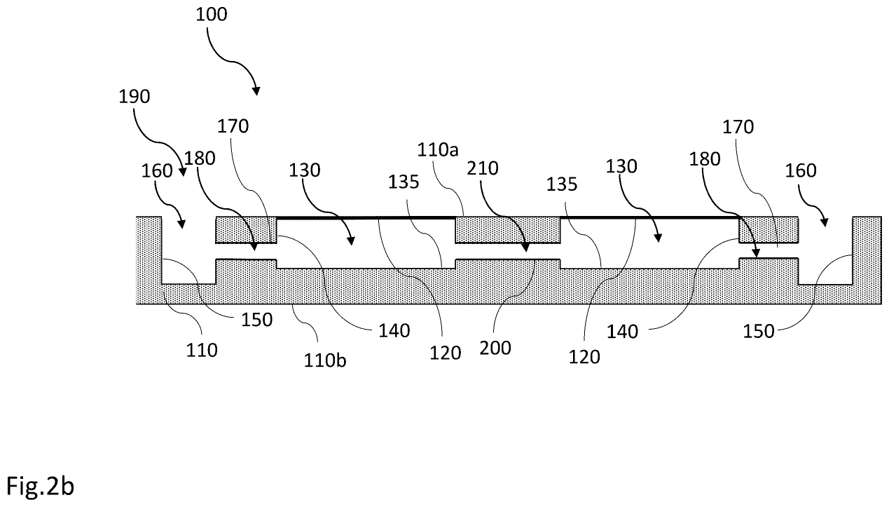

FIG. 2a is a schematic illustration of a cross-section of an ultrasonic transducer 100 according to an embodiment having a plurality of membranes. The ultrasonic transducer 100 of FIG. 2 comprises two membranes 120. Each of the two membranes 120 is arranged to be suspended at a distance from a respective cavity surface 135 of the substrate 110 at the backside 110b of the substrate 110.

The plurality of membranes 120 define a plurality of cavities 130. Each cavity 130 is defined between a respective membrane 120, a respective cavity surface 135 and at least one respective cavity wall 140. In other words, each membrane 120 may be associated with a unique cavity surface 135 and at least one unique cavity wall 140. The cavity 130 is defined by the membrane 120 together with the cavity surface 135 and the cavity walls 140 associated with the membrane 120. The cavities 130 are defined in a similar manner to the single cavity in FIG. 1a. However, it should be realized that the cavities 130 may instead be defined in a similar manner to the single cavity in FIG. 1c.

Each membrane 120 is configured to transversally vibrate similar to the vibration of the membrane discussed above in relation to FIG. 1b.

The ultrasonic transducer 100 comprises at least one connecting channel wall 200. The at least one connecting channel wall 200 defines at least one connecting channel 210 between different cavities 130 of the plurality of cavities 130. In FIG. 2a, the ultrasonic transducer 100 comprises two cavities 130 and a single connecting channel 210 connecting the cavities 130.

In the ultrasonic transducer of FIG. 2, both cavities 130 associated with a respective membrane 120 are fluidly connected to a respective venting hole 160 via respective venting channels 180. It should be noted that a different number of venting holes 160 may be possible, and that a different number of venting holes may change the acoustic resonance frequency. However, the volume spanned by interconnected cavities 130 and channels 210, 180, has fluid connection with at least one venting hole 160.

The volumes of the cavities, venting holes and venting channels are such that a square root of a ratio defined by a sum of cross-sectional area of each venting hole 160 divided by a sum of a volume of each cavity 130 multiplied by the length of the venting channel is within a range of 400-20000, such as in a range of 400-1000, or in a range of 1000-2000. Thus, the below expression may be within a range of 400-20000, such as in a range of 400-1000, or in a range of 1000-2000:

$$\sqrt{\frac{{Σ}_{i = 1}^{n} cross - {sectional}_{{area}_{{venting}_{{hole}_{i}}}}}{{Σ}_{j = 1}^{m} ( {Volume}_{{cavity}_{j}} ) * {Length}_{{venting}_{channel}}}} ,$$

where n is a number of venting holes and m is a number of cavities, assuming that the length of the venting channels are equal.

Thus, the parameters of sizes and shapes of venting holes 160, venting channels 180, and cavities 130 may be selected using the above-defined expression. This may ensure that the acoustic resonance frequency is provided within a desired range. The acoustic resonance frequency f_{H} may further be given by:

$${f}_{H} = \frac{v}{2 π} \sqrt{\frac{{Σ}_{i = 1}^{n} cross - {sectional}_{{area}_{{venting}_{{hole}_{i}}}}}{{Σ}_{j = 1}^{m} ( {Volume}_{{cavity}_{j}} ) * {Length}_{{venting}_{channel}}}} ,$$

where v is speed of sound in the fluid medium.

The connecting channel 210 may be short and have a relatively large cross-section such that there is substantially no pressure loss in flow of the fluid medium through the connecting channel 210. Thus, the connecting channel 210 may be configured to connect different cavities 130 to be in fluid connection with each other without the connecting channel 210 affecting the acoustic resonance frequency.

FIG. 2b is a schematic illustration of a cross-section of an ultrasonic transducer 100 according to another embodiment having a plurality of membranes.

The ultrasonic transducer 100 shown in FIG. 2b is similar to the ultrasonic transducer shown in FIG. 2a. In FIG. 2a, the membranes are located at the backside 110b of the substrate, whereas in FIG. 2b, the membranes 120 are located at the frontside 110a of the substrate 110. Thus, membranes 120 and their respective cavities 130 may be located on the same or opposite sides as the venting hole 160. This may be beneficial e.g. in applications where the transversal movement of the membrane 120 is restricted on either side of the substrate 110, such that the membrane 120 may be arranged at a side of the substrate 110 where transversal movement of the membrane 120 is not restricted.

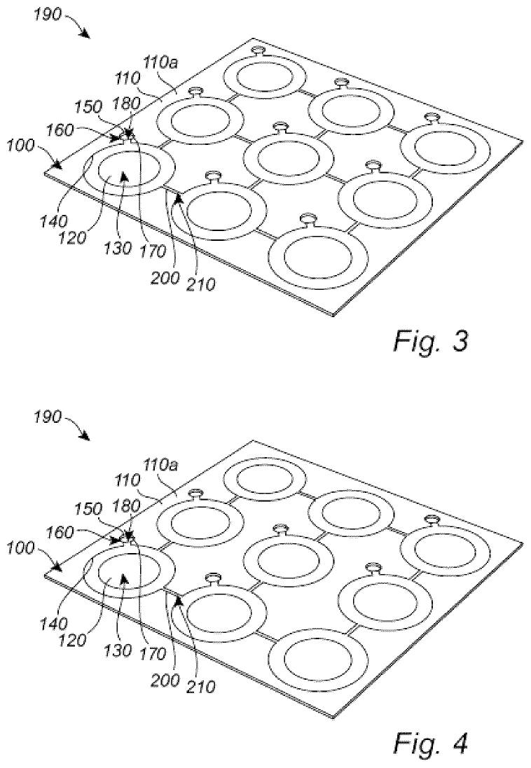

FIG. 3 is a schematic perspective view of an ultrasonic transducer 100 according to an embodiment. The ultrasonic transducer 100 of FIG. 3 comprises a plurality of membranes 120 arranged in a regular two-dimensional array.

The ultrasonic transducer comprises a plurality of cavities 130. Each of the plurality of cavities 130 is associated with a respective membrane. It should be noted that in alternative embodiments (not shown), the ultrasonic transducer 100 may in some locations of the array not be provided with a membrane and in such locations there may instead be a continuous surface of the substrate 100 for example in order to reduce costs or in order to customize resonance frequency properties of the transducer.

Each of the plurality of cavities 130 is connected to at least one other of the plurality of cavities 130 by a connecting channel 210. All cavities of the ultrasonic transducer 100 of FIG. 3 are connected. All cavities 130 are in fluid connection with each other and the volume of the interconnected cavities 130 and connecting channels 210 is in fluid connection with an external medium 190 via at least one venting hole 160 and a corresponding venting channel 180.

The substrate 110 of the ultrasonic transducer of FIG. 3 comprises a plurality of venting hole walls 150. The venting hole walls are located at the frontside 110a of the substrate 110. The plurality of venting hole walls define a plurality of venting holes. It should be noted that each venting hole can be defined by one or more venting hole walls. Thus a set comprising one or more venting hole walls of the plurality of venting hole walls can define a respective venting hole.

The substrate 110 further comprises a plurality of venting channel walls 170 for defining a plurality of venting channels 180. The plurality of venting channels are configured to connect a respective venting hole 160 of the plurality of venting holes 160 to a respective cavity 130. It should be noted that in alternative embodiments (not shown), one cavity may be connected to more than one venting hole via a corresponding number of venting channels. Further, some cavities may lack direct connection to a venting hole via a venting channel.

The ultrasonic transducer of FIG. 3 comprises 9 interconnected cavities arranged in a 3×3 array. It should be noted that different numbers of cavities and different arrangements (not shown) are also possible.

FIG. 4 is a schematic perspective view of an ultrasonic transducer 100 according to another embodiment having a plurality of membranes 120. The ultrasonic transducers 100 of FIGS. 4 and 3 may be seen as variations of each other.

In FIG. 4, an ultrasonic transducer 100 is illustrated, wherein the arrangement of venting holes not being identical in relation to each cavity 130 is illustrated. Thus, as shown in FIG. 4, the regular arrangement of venting holes and connecting channels of the ultrasonic transducer shown in FIG. 3 need not be necessarily used. Rather, in the ultrasonic transducer 100 shown in FIG. 4, three cavities 130 lack direct connection to a venting hole via respective venting channels.

Also, the central cavity 130 of the ultrasonic transducer 100 of FIG. 4 comprises two connecting channels, compared to the central cavity of the ultrasonic transducer of FIG. 3, which has four connecting channels. The above differences between the ultrasonic transducers of FIG. 4 and FIG. 3 lead to different total volumes of their respective interconnected cavities 130, respective connecting channels 210, venting channels 180 and venting holes 160. The difference in total volume may lead to different acoustic frequencies. The differences in the configuration of connecting channels and venting holes may alter the flow of a fluid medium throughout the cavities 130, connecting channels as well as the total volume of all interconnected cavities, venting holes and channels. These factors may alter the acoustic frequency.

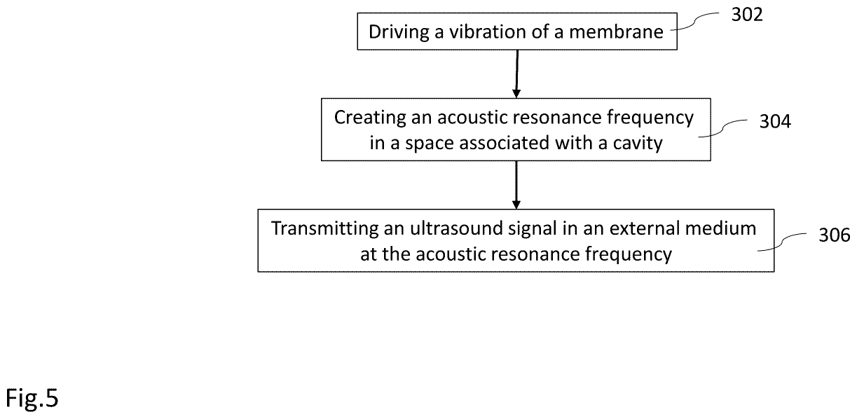

FIG. 5 is a simplified flowchart illustrating steps in a method for transmitting an ultrasound wave. The method uses an ultrasonic transducer according to any version described herein.

The method comprises driving 302 a vibration of a membrane of an ultrasonic transducer. The membrane is arranged to be suspended at a distance from a cavity surface of a substrate of the ultrasonic transducer. A cavity is defined between the membrane, the cavity surface and at least one cavity wall of the ultrasonic transducer. The membrane is configured to transversally vibrate based on driving of the vibration. The substrate of the ultrasonic transducer comprises at least one venting hole wall at the frontside for defining a venting hole. The venting hole may be laterally displaced from the membrane at the frontside of the substrate. The substrate comprises at least one venting channel wall for defining a venting channel extending within the substrate.

The venting channel is configured to connect the cavity to the venting hole. The transducer has an acoustic resonance frequency. The membrane has a membrane resonance frequency, The acoustic resonance frequency is different from the membrane resonance frequency.

The method comprises creating 304 acoustic resonance in the transducer by driving the membrane at the acoustic resonance frequency. Thus, acoustic resonance is created in the fluidly connected space comprising the cavity, the venting channel and the venting hole.

The method further comprises transmitting 306 the ultrasound wave into an external medium at the acoustic resonance frequency.

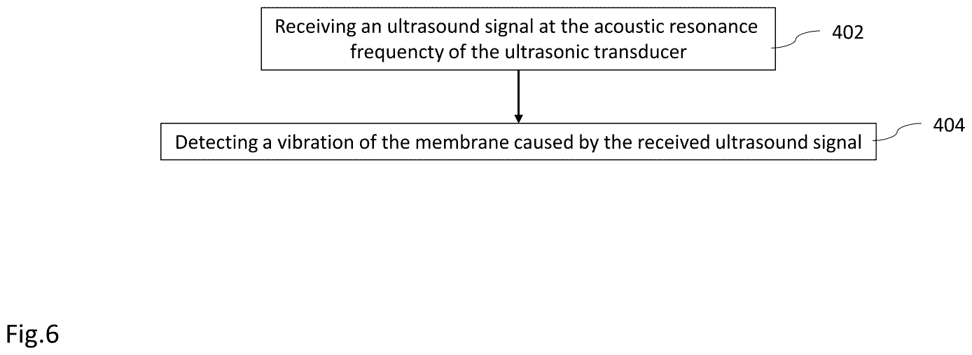

FIG. 6 is a simplified flowchart illustrating steps in a method for receiving an ultrasound wave. The method uses an ultrasonic transducer according to any version described herein.

The method comprises receiving 402 the ultrasound wave at an ultrasonic transducer. The ultrasonic transducer comprises a substrate comprising a frontside. The frontside is configured to face an external medium in which the ultrasound wave is propagating. The transducer comprises a membrane arranged to be suspended at a distance from a cavity surface of the substrate. A cavity is defined between the membrane, the cavity surface and at least one cavity wall. The membrane is configured to transversally vibrate upon the ultrasound wave being received.

The substrate comprises at least one venting hole wall at the frontside for defining a venting hole at the frontside. The venting hole may be laterally displaced form the membrane at the frontside of the substrate. The substrate further comprises venting channel walls for defining a venting channel extending within the substrate and configured to connect the cavity to the venting hole. The transducer has an acoustic resonance frequency. The membrane has a membrane resonance frequency. The acoustic resonance frequency is different from the membrane resonance frequency.

The received ultrasonic wave has a frequency corresponding to the acoustic resonance frequency.

The method further comprises detecting 404 a vibration of the membrane at the frequency of the ultrasound wave, wherein the vibration is caused by the received ultrasound wave.

In the above the inventive concept has mainly been described with reference to a limited number of examples. However, as is readily appreciated by a person skilled in the art, other examples than the ones disclosed above are equally possible within the scope of the inventive concept, as defined by the appended claims.

1. An ultrasonic transducer comprising:
a substrate comprising a frontside configured to face an external medium for propagation of an ultrasound wave; and
a membrane arranged to be suspended at a distance from a cavity surface of the substrate for defining a cavity between the membrane, the cavity surface, and at least one cavity wall, wherein the membrane is configured to transversally vibrate;
wherein the ultrasonic transducer comprises at least one venting hole wall at the frontside for defining a venting hole at the frontside;
wherein the ultrasonic transducer further comprises at least one venting channel wall defining a venting channel configured to connect the cavity to the venting hole;
wherein the transducer has an acoustic resonance frequency and the membrane has a membrane resonance frequency, wherein the acoustic resonance frequency is different from the membrane resonance frequency, and wherein the ultrasonic transducer is configured to provide transduction for the ultrasound wave propagating in the external medium, wherein the ultrasound wave has a frequency corresponding to the acoustic resonance frequency.

2. The ultrasonic transducer according to claim 1, wherein the acoustic resonance frequency is lower than the membrane resonance frequency.

3. The ultrasonic transducer according to claim 1, further comprising a control unit configured to control the membrane to vibrate at the acoustic resonance frequency.

4. The ultrasonic transducer according to claim 1, wherein the acoustic resonance frequency is in a range of 20 KHz-1 MHz, such as in a range of 40-300 kHz, such as in a range of 60-200 KHz.

5. The ultrasonic transducer according to claim 1, wherein a size of the membrane is smaller than 400 μm, such as smaller than 250 μm.

6. The ultrasonic transducer according to claim 1, wherein the ultrasonic transducer comprises a plurality of membranes, each arranged to be suspended at a distance from a respective cavity surface of the substrate, wherein the plurality of membranes define a plurality of cavities, wherein each cavity is defined between a respective membrane, a respective cavity surface, and at least one respective cavity wall, wherein each membrane is configured to transversally vibrate, wherein the ultrasonic transducer comprises at least one connecting channel wall defining at least one connecting channel between different cavities of the plurality of cavities.

7. The ultrasonic transducer according to claim 6, wherein each of the plurality of cavities is connected to at least one other cavity in the plurality of cavities by a connecting channel of the at least one connecting channel, wherein all cavities of the plurality of cavities are connected.

8. The ultrasonic transducer according to claim 6, wherein the ultrasonic transducer comprises a plurality of venting hole walls, at the frontside for defining respective venting holes at the frontside, wherein the ultrasonic transducer further comprises venting channel walls defining a plurality of venting channels configured to connect a respective venting hole of the plurality of venting holes to a respective cavity of the plurality of cavities.

9. The ultrasonic transducer according to claim 8, wherein a square root of a ratio defined by a sum of cross-sectional areas of each venting hole divided by a product of a volume of each cavity multiplied by the length of the venting channel is within a range of 400-20000, such as in a range of 400-1000, or in a range of 1000-2000.

10. The ultrasonic transducer according to claim 1, wherein the ultrasonic transducer is a capacitive micromachined ultrasonic transducer, CMUT.

11. The ultrasonic transducer according to claim 1, wherein the ultrasonic transducer is a piezoelectric micromachined ultrasonic transducer, PMUT.

12. A method for transmitting of an ultrasound wave, said method comprising:
driving a vibration of a membrane of an ultrasonic transducer, wherein the membrane is arranged to be suspended at a distance from a cavity surface of a substrate of the ultrasonic transducer for defining a cavity between the membrane, the cavity surface, and at least one cavity wall of the ultrasonic transducer, wherein the membrane is configured to transversally vibrate, wherein the ultrasonic transducer comprises at least one venting hole wall at the frontside for defining a venting hole at the frontside, wherein the ultrasonic transducer further comprises at least one venting channel wall defining a venting channel configured to connect the cavity to the venting hole, wherein the transducer has an acoustic resonance frequency and the membrane has a membrane resonance frequency, wherein the acoustic resonance frequency is different from the membrane resonance frequency, wherein the membrane is driven at the acoustic resonance frequency; and
transmitting the ultrasound wave into an external medium at the acoustic resonance frequency.

13. A method for detecting of an ultrasound wave, said method comprising:
receiving the ultrasound wave at an ultrasonic transducer comprising: a substrate comprising a frontside configured to face an external medium for propagation of the ultrasound wave; a membrane arranged to be suspended at a distance from a cavity surface of the substrate for defining a cavity between the membrane, the cavity surface, and at least one cavity wall, wherein the membrane is configured to transversally vibrate; wherein the ultrasonic transducer comprises at least one venting hole wall at the frontside for defining a venting hole at the frontside, wherein the ultrasonic transducer further comprises at least one venting channel wall defining a venting channel configured to connect the cavity to the venting hole, wherein the transducer has an acoustic resonance frequency and the membrane has a membrane resonance frequency, wherein the acoustic resonance frequency is different from the membrane resonance frequency, wherein the received ultrasound wave has a frequency corresponding to the acoustic resonance frequency; and
detecting a vibration of the membrane at the frequency of the ultrasound wave, wherein the vibration is caused by the received ultrasound wave.
